(19) United States
(12) Patent Application Publication
(10) Pub. No.: US 2012/0091285 A1
(43) Pub. Date: Apr. 19, 2012

(54) AIRCRAFT NACELLE INCLUDING A CONTINUE JOINT AREA BETWEEN AN OUTER WALL AND A FRONT FRAME

(75) Inventors: Alain PORTE, Colomiers (FR); Frederic CHELIN, Encausse (FR)

(73) Assignee: AIRBUS OPERATIONS (S.A.S), Toulouse (FR)

(21) Appl. No.: 13/270,665

(22) Filed: Oct. 11, 2011

(30) Foreign Application Priority Data
Oct. 15, 2010 (FR) 1058436

(51) Int. Cl. B64D 33/02; B29C 70/30

(52) U.S. Cl. 244/53 B; 156/243

(57) ABSTRACT

An aircraft nacelle includes a lip that is extended inside the nacelle by an inside wall that delimits a pipe that empties at a power plant and outside of the nacelle by an outside wall, a first frame called a front frame that connects the inside wall and the outside wall, delimiting an annular pipe with the lip, and a second frame called a rear frame that connects the inside wall and the outside wall close to the power plant, characterized in that it includes at least one junction zone—at at least one cross-section of the nacelle along a plane that contains the longitudinal axis of the nacelle—an element that constitutes at least one part of the outside wall and at least one part of the front frame and that includes an offset whose shapes are suitable for accommodating a panel that forms the lip.

This invention relates to an aircraft nacelle that incorporates a continuous junction zone between an outside wall and a front frame.

An aircraft propulsion system comprises a nacelle in which a power plant is arranged in an essentially concentric manner.

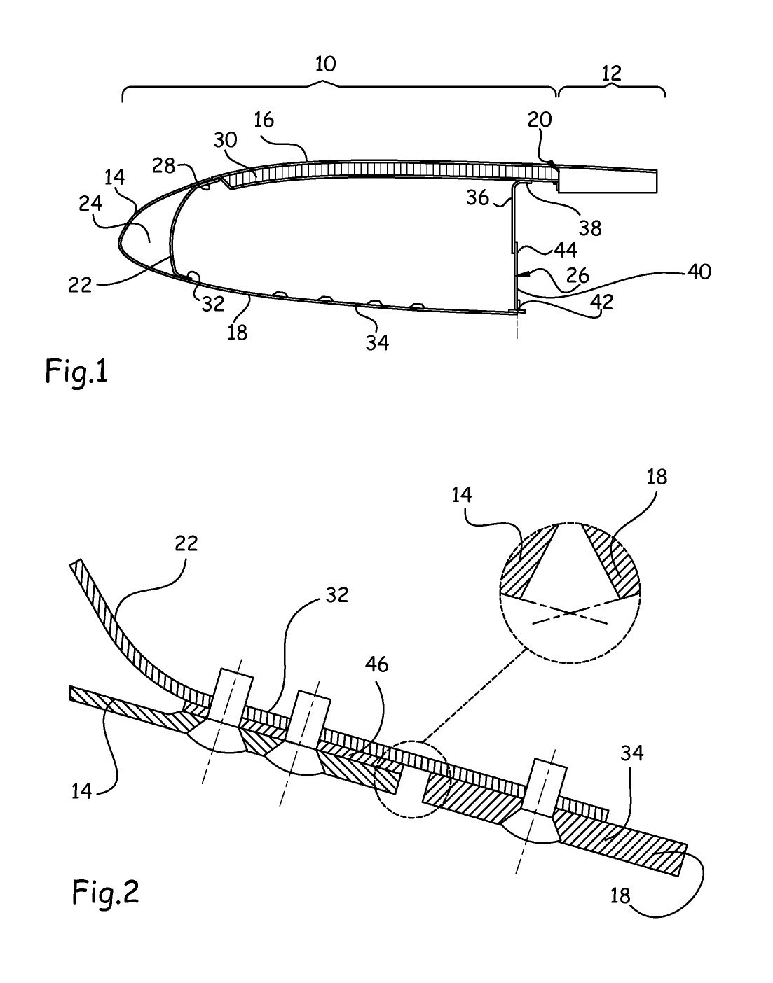

As illustrated in FIG. 1, the nacelle comprises an air intake 10 at the front that makes it possible to channel a stream of air in the direction of the power plant 12, with a first part of the incoming air stream, called the primary stream, passing through the power plant to take part in the combustion process, and with the second part of the air stream, called the secondary stream, being entrained by a fan and flowing into an annular pipe that is delimited by the inside wall of the nacelle and the outside wall of the power plant.

The air intake 10 comprises a lip 14 of which the surface that is in contact with the aerodynamic streams is extended inside the nacelle by an inside wall 16 that delimits a pipe and outside of the nacelle by an outside wall 18.

The air intake 10 is connected to the power plant 12 at a junction surface 20 by any suitable means. The junction surface 20 is essentially flat and perpendicular to the longitudinal axis of the nacelle.

On the structural plane, the air intake 10 comprises a first frame called a front frame 22 that connects the inside wall 16 and the outside wall 18 that delimits an annular pipe 24 with the lip 14 and a second frame called a rear frame 26 that connects the inside wall 16 and the outside wall 18 close to the junction surface 20 of the power plant.

According to one embodiment, the front frame 22 comprises—at the inside wall—an edge 28 that is curved toward the rear of the nacelle against which are flattened one edge of a panel forming the lip 14 and one edge of another panel 30 forming the inside wall 16, whereby said edges are placed end to end. Advantageously, the panel 30 ensures the acoustic treatment and comprises an alveolar structure that imparts a certain rigidity to it.

In addition, at the outside wall 18, the front frame 22 comprises an edge 32 that is curved toward the rear of the nacelle against which at least a part of the panel forming the lip is flattened. The outside wall 18 is formed by a panel 34 that is independent of the panel that forms the lip 14. In this case, the adjacent edges of the panel 34 and the panel forming the lip 14 are placed end to end and flattened against the curved edge 32. The panel that forms the lip 14 is generally metallic in order to be compatible with a system for treating frost or ice using hot air that is provided at the air intake, and the panel 34 is made of composite material for reducing the on-board weight.

Relative to the rear frame, the latter ensures the absorption of flexural forces, rotational forces, etc., that impinge on the air intake, such as, for example, the weight of the air intake, the forces induced by the aerodynamic flows. This rear frame 26 is arranged in a plane that is essentially perpendicular to the longitudinal direction of the nacelle.

A rear frame is described in particular in the document FR-2,904,604.

It comprises a first metal ring 36, in particular made of titanium and which extends over the entire periphery and which comprises—at its smallest diameter—a flange 38 against which the inside wall 16 that is attached to said flange 38 by any suitable means can rest. The rear frame 26 comprises a second ring 40 whose outside diameter is connected by any suitable means to the outside wall 18. According to the illustrated example, the second ring 40 is connected to the outside wall 18 by means of a peripheral separating piece 42 with a T-shaped cross-section, whereby said second ring 40 is connected at the foot of the T-shaped separating piece, and the head of the T serves as a support for the outside wall 18.

At its outside peripheral edge, the first ring 36 comprises a zone for overlapping with the inside peripheral edge of the second ring 40, with the two rings being connected by any suitable means at this overlapping zone 44.

At the outside wall, the panel(s) forming the lip 14, the panel(s) forming the outside wall 18, and the panel(s) delimiting the outside surface of the nacelle after the rear frame are connected to the front frame or to the rear frame by suitable connecting means, such as, for example, rivets. To reduce the influence on the drag, these different panels are placed end to end and do not overlap.

Even if it is possible to adapt the thicknesses of the panels placed end to end using peel-off or machinable wedges 46, the lack of surface continuity between the outside surfaces of the panels placed end to end cannot be corrected. This defect at the junction of the panels of the outside surface 18 and the lip 14 generates disturbances that tend to increase the drag and consequently the energy consumption of the aircraft.

The document FR-2,932,106 proposes an approach that aims at resolving this problem that consists in creating a shallow groove relative to the continuous theoretical surface, which extends over a width such that the outside surfaces of the panels placed end to end no longer project relative to the theoretical surface, and in depositing a coating in the groove in such a way as to fill it in.

The purpose of this invention is to propose an alternative that makes it possible to reduce the assembly times of elements forming an air intake and to limit the impact of junction zones on the aerodynamics.

For this purpose, the invention has as its object an aircraft nacelle that comprises, on the one hand, a lip that is extended inside the nacelle by an inside wall that delimits a pipe that empties at a power plant and outside of the nacelle by an outside wall, and, on the other hand, a first frame called a front frame that connects the inside wall and the outside wall, delimiting with the lip an annular pipe, and a second frame called a rear frame that connects the inside wall and the outside wall close to the power plant, characterized in that it comprises at least one junction zone with—at at least one cross-section of the nacelle along a plane containing the longitudinal axis of the nacelle—an element that constitutes at least one part of the outside wall and at least one part of the front frame and that comprises an offset whose shapes are suitable for accommodating a panel that forms the lip.

Other characteristics and advantages will emerge from the following description of the invention, a description that is provided only by way of example, relative to the accompanying drawings, in which:

FIG. 1 is a cutaway of an air intake of an aircraft nacelle according to the prior art,

FIG. 2 is a cutaway that illustrates in detail the junction zone of two panels placed end to end forming the outside wall of an aircraft nacelle according to the prior art,

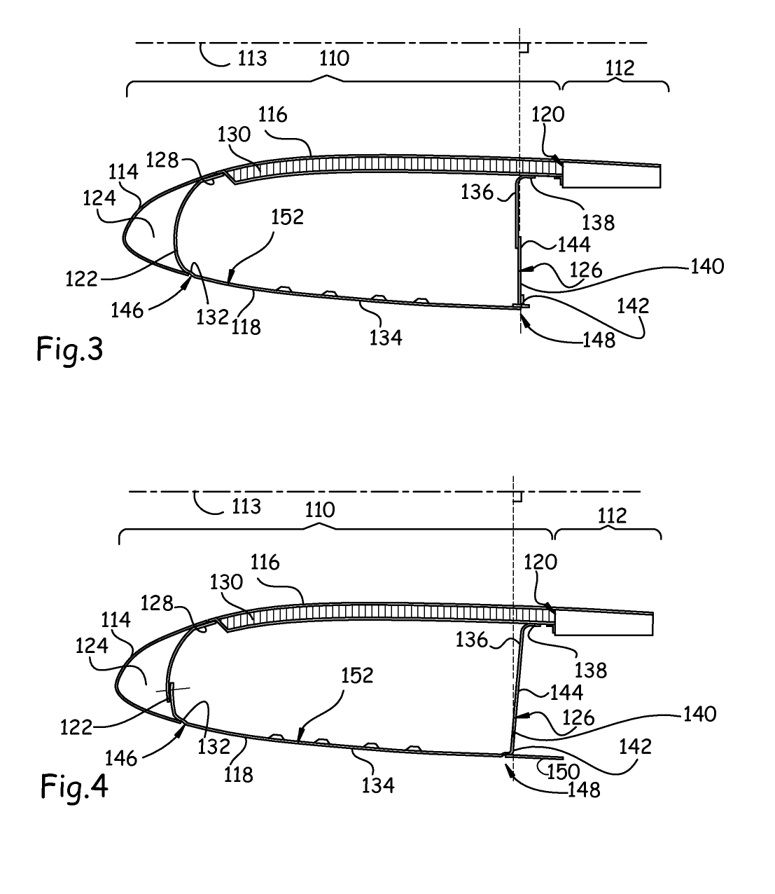

FIG. 3 is a cutaway of an air intake of an aircraft nacelle according to a variant of the invention,

FIG. 4 is a cutaway of an air intake of an aircraft nacelle according to another variant of the invention,

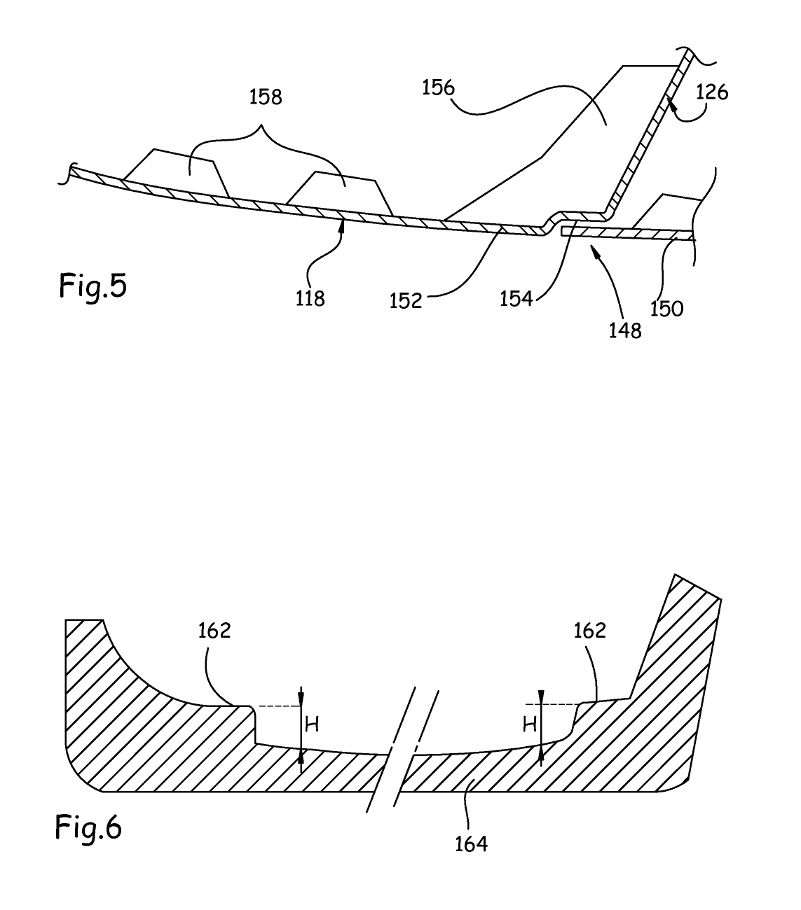

FIG. 5 is a cutaway that illustrates in detail the junction zone of the elements forming the outside wall of an aircraft nacelle according to the variant of the invention that is illustrated in FIG. 4, and

FIG. 6 is a cutaway that illustrates a mold that makes it possible to produce an outside wall according to the variant of the invention that is illustrated in FIG. 4.

FIGS. 3 to 5 show a nacelle with—at the front—an air intake 110 that makes it possible to channel a stream of air in the direction of a power plant 112, with a first part of the incoming air stream, called the primary stream, passing through the power plant to take part in the combustion process, and with the second part of the air stream, called the secondary stream, being entrained by a fan and flowing into an annular pipe that is delimited by the inside wall of the nacelle and the outside wall of the power plant. Hereinafter, the longitudinal axis 113 of the nacelle corresponds to the axis of rotation of the power plant.

The air intake 110 comprises a lip 114 whose surface that is in contact with the aerodynamic streams is extended inside the nacelle by an inside wall 116 that delimits a pipe and outside of the nacelle by an outside wall 118.

The air intake 110 is connected to the power plant 112 at a junction zone 120 by any suitable means.

On the structural plane, the air intake 110 comprises a first frame called a front frame 122 that connects the inside wall 116 and the outside wall 118, delimiting with the lip 114 an annular pipe 124, and a second frame called a rear frame 126 that connects the inside wall 116 and the outside wall 118 close to the junction surface 120 of the power plant.

These frames 122 and 126 can each comprise at least one opening for allowing the passage of a pipe that is provided for supplying a frost treatment system with hot air at the lip.

The power plant 112, the inside wall 118, and the lip 114 are not described in more detail because they are known to one skilled in the art and can be, for example, consistent with the prior art.

According to an embodiment that is illustrated in FIG. 3, the front frame 122 comprises—at the inside wall 116—an edge 128 that is curved toward the rear of the nacelle against which are flattened one edge of a panel forming the lip 114 and one edge of another panel 130 forming the inside wall 116, whereby said edges are placed end to end. Advantageously, the panel 130 ensures an acoustic treatment and comprises an alveolar structure that imparts a certain rigidity to it.

The outside wall 118 is formed by a panel 134 that is independent of the panel that forms the lip 114.

The panel that forms the lip 114 is generally metallic to be compatible with a system for treating frost or ice using hot air that is provided at the air intake.

According to one embodiment that is illustrated in FIG. 3, the rear frame 126 comprises a first metal ring 136, in particular made of titanium, which comprises—at its smallest diameter—a curved edge 138 against which the inside wall 116 that is attached to said curved edge 138 by any suitable means can rest. Advantageously, the curved edge 138 has an end that is oriented toward the rear of the nacelle.

In addition, the rear frame comprises a second ring 140 whose outside diameter is connected by any suitable means to the outside wall 118.

According to an embodiment that is illustrated in FIG. 3, the second ring 140 can be connected to the outside wall 118 by means of a peripheral separating piece 142 with a T-shaped cross-section, whereby said second ring 140 is connected at the foot of the T-shaped separating piece, and the head of the T serves as a support for the outside wall 118.

At its outside peripheral edge, the first ring 136 comprises a zone 144 for overlapping with the inside peripheral edge of the second ring 140, with the two rings being connected by any suitable means at this overlapping zone 144.

This second ring 140 is preferably made of composite material.

According to another embodiment, the rear frame can be made of a single piece of composite material.

At the outside wall 118, the outside wall comprises two junction zones 146 and 148, a first junction zone 146 between the front frame 122, with the panel(s) forming the lip 114 and the panel(s) forming the outside wall 118, and a second junction zone 148 between the rear frame 126, with the panel(s) forming the outside wall 118, and one or more panel(s) 150 located facing the power plant 112, ensuring the extension of the outside wall 118 and optionally comprising articulated portions for allowing access to said power plant 112.

According to the invention, at least one junction zone 146 comprises—at at least one cross-section of the nacelle along a plane that contains the longitudinal axis 113 of the nacelle—an integral element 152 that constitutes at least a part of the outside wall 118 and at least a part of the front frame 122 and comprises an offset 154 whose shapes are suitable for accommodating the panel that forms the lip 114. Advantageously, the element 152 forms at least a part of the rear frame 126 and comprises an offset 154 whose shapes are suitable for accommodating the panel 150 located facing the power plant. Thus, the height of the offset 154 corresponds to the thickness of the panel that forms the lip or the panel 150 that is located facing the power plant. This arrangement makes it possible to improve the continuity of surfaces in contact with the streams that flow outside of the nacelle and to reduce the impact of the junction zone on the aerodynamics because the same element 152 comprises—at the junction zone—a surface of which one part is in contact with the streams that flow outside of the nacelle and another part serves as a support surface to the panel to be assembled. According to another aspect, with the offset 154 being adapted to the thickness of the panel to be assembled, it is no longer necessary to provide wedges at the time of mounting, which tends to reduce the time that is necessary for assembly.

Thus, the element 152 comprises at least one surface that can be in contact with the streams that flow outside of the nacelle. In addition, a part of the element 152 extends in a direction that is secant with the longitudinal axis 113 over a height that corresponds to at least 10% of the front frame and optionally the rear frame.

The element 152 can extend over the entire circumference or can comprise several angular sectors placed end to end along the circumference, with each angular sector being made integral in the longitudinal direction.

Advantageously, the element 152 extends from the front frame 122 to the rear frame 126 in such a way as not to generate the junction zone at the outside surface of the nacelle.

According to an embodiment that is illustrated in FIG. 3, the element 152 forms the front frame 122 and extends up to the inside pipe 116; its front edge extends in a curved manner in such a way as to serve as a support to the panels that form the lip 114 and to those that form the inside pipe 116. It also extends over the entire length of the outside wall 118, and its downstream edge is made integral with the rear frame 126 in the same manner as for the prior art, for example.

According to the example that is illustrated in FIG. 4, the element 152 could form the entire rear frame 126 and extend up to the inside wall 116 at the rear frame.

According to an embodiment that is illustrated in FIG. 4, the element 152 forms a part of the front frame 122, also extends over the entire length of the outside wall 118, and forms the entire rear frame 126 and extends up to the inside wall 116.

According to a variant that is not shown, the element 152 could form only a part of the rear frame 126.

Preferably, the element 152 comprises stiffeners, for example stiffeners 156 in planes that contain the longitudinal axis 113 and/or stiffeners 158 that extend into transverse planes (perpendicular to the longitudinal axis 113).

According to another characteristic of the invention, the element 152 is made of composite material.

Preferably, the element 152 is obtained by draping folds of fibers over a mold 160 whose surface is in accordance with the surface of the element 152 that can be in contact with the streams that flow outside of the nacelle.

According to the invention, this mold 160 comprises at least one projecting shape that forms a progression 162 that corresponds to the offset 154 and whose height H is adapted to the thickness of the panel that will be assembled subsequently at said junction zone.

To facilitate the demolding, the part of the element 152 that forms a part of the front frame 122 forms an angle that is greater than 90° with the part of the element 152 that forms the outside wall 118. Likewise, the part of the element 152 that forms a part of the rear frame 126 forms an angle that is greater than 90° with the part of the element 152 that forms the outside wall 118.

FIG. 6 shows a mold 160 for producing an element 152 according to the variant that is illustrated in FIG. 4, which comprises two progressions 162, one for each junction zone.

1. Aircraft nacelle that comprises, on the one hand, a lip (114) that is extended inside the nacelle by an inside wall (116) that delimits a pipe that empties at a power plant (112) and outside of the nacelle by an outside wall (118), and, on the other hand, a first frame called a front frame (122) that connects the inside wall (116) and the outside wall (118), delimiting an annular pipe (124) with the lip (114), and a second frame called a rear frame (126) that connects the inside wall (116) and the outside wall (118) close to the power plant (112. The outside wall comprises at least one junction zone (146, 148) with—at at least one cross-section of the nacelle along a plane that contains the longitudinal axis (113) of the nacelle—an element (152) that constitutes at least one part of the outside wall (118) and at least one part of the front frame (122) and that comprises an offset (154) whose shapes are suitable for accommodating a panel that forms the lip (114).

2. Aircraft nacelle according to claim 1, wherein a part of the element (152) constitutes a part of the rear frame (126) and comprises an offset (154) whose shapes are suitable for accommodating a panel that is located facing the power plant at the outside wall.

3. Aircraft nacelle according to claim 1, wherein a part of the element (152) extends in a direction that is secant with the longitudinal axis (113) of the nacelle over a height that corresponds to at least 10% of at least one of the two frames (122, 126).

4. Aircraft nacelle according to claim 2, wherein the element (152) extends from the front frame (122) to the rear frame (126).

5. Aircraft nacelle according to claim 1, wherein the element (152) forms the front frame (122) and extends up to the inside pipe (116).

6. Aircraft nacelle according to claim 1, wherein the element (152) forms a part of the rear frame (126).

7. Aircraft nacelle according to claim 1, wherein the element (152) forms the rear frame (126) and extends up to the inside pipe (116).

8. Process for the production of an element (152) that forms a part of an outside wall (118) of an aircraft nacelle according to claim 1, whereby said nacelle comprises, on the one hand, a lip (114) that is extended inside the nacelle by an inside wall (116) that delimits a pipe that empties at a power plant (112) and outside of the nacelle by the outside wall (118), and, on the other hand, a first frame called a front frame (122) that connects the inside wall (116) and the outside wall (118) that delimits an annular pipe (124) with the lip (114), and a second frame called a rear frame (126) that connects the inside wall (116) and the outside wall (118) close to the power plant (112), wherein the element (152) is made of composite material and obtained by draping folds of fibers on a mold (160) with at least one projecting form forming a progression (162) that corresponds to an offset (154) and whose height H is adapted to the thickness of a panel that forms the lip (114).

9. Aircraft nacelle according to claim 2, wherein a part of the element (152) extends in a direction that is secant with the longitudinal axis (113) of the nacelle over a height that corresponds to at least 10% of at least one of the two frames (122, 126).

10. Aircraft nacelle according to claim 3, wherein the element (152) extends from the front frame (122) to the rear frame (126).

11. Aircraft nacelle according to claim 9, wherein the element (152) extends from the front frame (122) to the rear frame (126).
